(19) United States
(12) Patent Application Publication
(10) Pub. No.: US 2013/0312275 A1
(43) Pub. Date: Nov. 28, 2013

(54) Laundry Dryer

(71) Applicants: Massimo Castiglione, Fiume Veneto (IT); Diego Dal Ben, Zoppola (PN) (IT); Fabio Pasut, Pordenone (IT)

(72) Inventors: Massimo Castiglione, Fiume Veneto (IT); Diego Dal Ben, Zoppola (PN) (IT); Fabio Pasut, Pordenone (IT)

(73) Assignee: ELECTROLUX HOME PRODUCTS CORPORATION N.V., Brussels (BE)

(21) Appl. No.: 13/989,904

(22) PCT Filed: Nov. 24, 2011
(86) PCT No.: PCT/EP11/70983

§ 371 Date: Aug. 9, 2013

(30) Foreign Application Priority Data
Nov. 29, 2010 (EP) 10193005.5

(51) Int. Cl. F26B 21/08

(52) U.S. Cl. CPC F26B 21/08
USPC 34/73

(57) ABSTRACT

A laundry dryer includes a drying air circuit for circulating a drying air flow through laundry to be dried, a drying air moisture condensing unit and a condensate drawer tank (102) which is movable along a sliding path (A) relative to a housing (121). The condenser drawer tank (102) includes a condensate container (115) having a pouring opening (114) for collecting moisture condensed from the drying air flow. A guiding portion (128) is formed on an outer surface (127) of the condensate container (115) and extends parallel to the sliding path (A). The guiding portion (128) is arranged in proximity of a pouring opening (114) for driving at least a structural element (109, 112) of the laundry dryer to slide over the pouring opening (114) when the condensate drawer tank (102) moves along the sliding path (A).

The present invention refers to a laundry dryer having an improved condensate drawer tank.

A laundry dryer of known type generally comprises a casing that houses a laundry container, like a rotating drum, where laundry to be treated is received, and a drying air circuit for carrying out a drying operation by circulating hot air through the laundry container. Such known laundry dryers generally comprise a heat exchanging unit provided within the drying air circuit for removing moisture from air passed through laundry to dried. Moisture removed from drying air is collected within a reservoir located in the cabinet bottom part and then it is pumped up to a removable container placed on a front upper portion of the cabinet by pumping means. A commonly used condensate removable container is in a form of an extractable drawer having a container provided with a pouring opening so as a user can periodically remove the drawer from the laundry drying machine and emptying condensate container through the pouring opening.

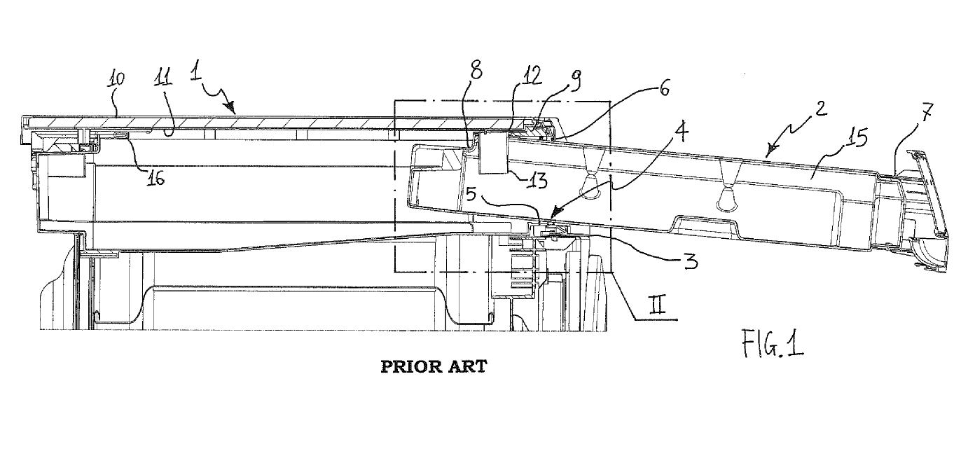

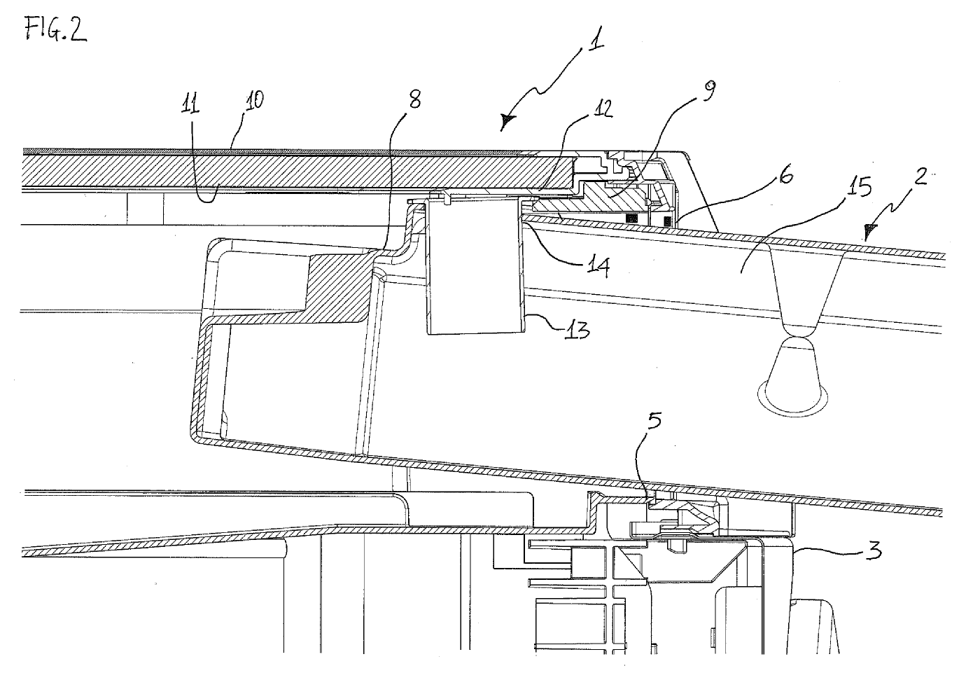

A top portion of a laundry dryer of the above described known type is shown in FIGS. 1 and 2. In particular, FIG. 1 schematically shows a sectional side view of a top portion of a known laundry drying machine 1 where condensate drawer tank 2 has been partially extracted from machine casing 3. FIG. 2 shows an enlarged view of detail “II” in FIG. 1.

As it can be seen in FIG. 1, when a condensate drawer tank 2 has to be extracted from a laundry dryer 1, it slides outwardly the casing 3 and, under the effect of the condensate weight, rotates about a resting portion 4 of a condensate container 15 through which condensate drawer tank 2 contacts a lower front edge 5 region of an opening 6 slidably receiving the condensate drawer tank 2. Due to such rotation (clockwise rotation in FIG. 1), a front end 7 of the condensate drawer tank 2 moves downwardly, and, consequently, a rear end 8 thereof moves upwardly interfering with a support structure 9 of the laundry dryer 1 frame and/or with supports 12 of a worktop 10 lower side 11. Such interference is better viewed in the enlarged detail “II” in FIG. 2.

A main drawback of the above described known laundry dryers consists in that said interference of the condensate drawer tank 2 rear end 8 may cause a pouring bush 13, which may be associated to a pouring opening 14 provided in a condensate container 15 for facilitating emptying operations of condensate drawer tank 2, to be hooked by a support structure 9 and/or by worktop 10 supports 12 and pulled out of opening 14. In case a portion of pouring bush 13 protruding from opening 14 is hooked, a further drawer 2 extracting movement performed by a user causes not only damages to bush 13 but also a sudden stop of condensate drawer tank 2 with a consequent condensate shedding. In addition, when bush 13 is hooked, a user has to undesirably move drawer 2 backward and forward so as to try to disengage the hooked pouring bush 13, thereby risking to pour condensate on floor. The same above mentioned problems arise even when bush 13 is formed by an annular embossing portion extending around the pouring opening 14 for guiding condensate in a controlled manner out of said opening 14.

The possibility that a condensate drawer tank 2 is hooked by components of a laundry dryer within the drawer housing increases whether the pouring bush 13 is slidably mounted within 14 so as to be extracted, but without being removed from the latter, for better driving condensate out of container 15 when a condensate drawer tank 2 emptying operation is carried out.

Furthermore, damages caused to the pouring bush 13, and in particular to its portion projecting from opening 14, may even compromise the correct fitting of bush 13 to a sleeve 16 which is provided for filling container 15 with condensate and arranged in a position of the laundry dryer corresponding to that of the bush 13 when drawer 2 is completely inserted within opening 6. As a consequence, not all condensate removed from laundry may be received within container 15 thereby causing a machine malfunction and an undesired repair intervention by specialized technicians.

Still another drawback of a laundry dryer described above, consists in that condensate accidentally poured out of the opening 14 is driven towards a user when the latter extracts drawer 2. This happens because, when almost completely extracted from opening 6, drawer 2 is inclined towards a user holding its front end 7 as shown in FIG. 1.

The aim of the present invention is therefore to solve the noted drawbacks and thus providing a laundry dryer having an improved condensate drawer tank that prevents interference between drawer and other components of the laundry dryer during its extraction and removal from the laundry drying machine.

An object of the present invention is to provide a laundry dryer having a condensate drawer tank that prevents uncontrolled condensate pouring when said drawer tank is moved from its housing.

A further object of the invention is to provide a laundry dryer comprising a condensate drawer tank that prevents condensate accidentally poured around its filling opening to be shed outside the laundry dryer.

Another object of the invention is to provide a laundry dryer wherein a condensate drawer tank may be reliably extracted from its housing without blocking.

Still another object of the present invention is to provide a laundry dryer having a condensate drawer tank suitable to compensate excessive dimensional tolerances and/or assembling tolerances without compromising its condensate collecting function.

A further object of the invention is to provide a laundry dryer comprising a condensate drawer tank that greatly reduces repair interventions by specialized technicians to restore laundry drying machine operation.

Advantages, objects, and features of the invention will be set forth in part in the description and drawings which follow and in part will become apparent to those having ordinary skill in the art upon examination of the following or may be learned from practice of the invention. The objects and advantages of the invention may be reached and attained as particularly pointed out in the appended claims. According to the present invention, there is provided a laundry dryer comprising a drying air circuit for circulating a drying air flow through laundry to be dried, a drying air moisture condensing unit and a condensate drawer tank, which is movable along a sliding path relative to a housing and comprises a condensate container having a pouring opening for collecting moisture condensed from said drying air flow, wherein said condensate drawer tank comprises a guiding portion formed on an outer surface of the condensate container and extending parallel to said sliding path, said guiding portion being arranged in proximity of a pouring opening for driving at least a structural element of the laundry dryer to slide over the pouring opening when the condensate drawer tank moves along the sliding path. Preferably, a bush is fitted into said pouring opening and comprises an annular portion protruding from said opening. Preferably, the bush is slidably associated to the pouring opening so as to be movable from a first resting position in which said bush is inserted within the condensate container and a second position wherein said bush is extracted from the container and locked on the pouring opening. Preferably, the guiding portion and the bush protrude of the same amount from the outer surface of the condensate container. Preferably, the guiding portion protrudes from the outer surface of the condensate container more than said bush so as to comprise a part extending higher than bush relative to the outer surface. Preferably, the guiding portion slopes down towards a graspable front end of condensate drawer tank. Preferably, the guiding portion is formed integrally with condensate container in a single unitary piece. Preferably, an embossment is arranged transversally to the condensate drawer tank sliding path on said outer surface between the pouring opening and a graspable front end of condensate drawer tank. Preferably, a portion of the outer surface slopes down towards a rear end of the condensate drawer tank and is provided between the embossment and said rear end. Preferably, a part of the surface portion extends around the pouring opening. Preferably, the guiding portion is formed between the embossment and the pouring opening. Preferably, the embossment is formed integrally with condensate container in a single unitary piece. Preferably, the guiding portion joins to an embossment arranged transversally to the condensate drawer tank sliding path at a joining region and a draining channel departs from said joining region along a further transversal direction relative to said sliding path.

The accompanying drawings, which are included to provide a further understanding of the invention and are incorporated in and constitute a part of this specification, illustrate possible embodiments of the invention and together with the description serve to explain the principles of the invention. Like reference numbers represents like features throughout the accompanying drawings, wherein:

FIG. 1 schematically shows a sectional side view of a top portion of a known laundry drying machine where a condensate drawer tank has been partially extracted from machine casing;

FIG. 2 shows an enlarged view of detail “II” in FIG. 1;

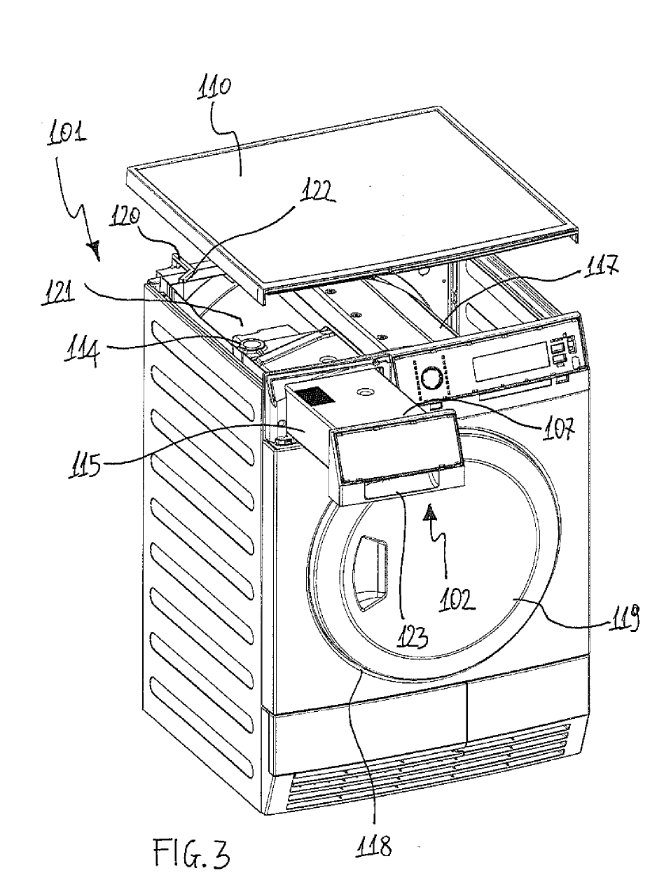

FIG. 3 shows a laundry dryer according to the invention with a partially extracted condensate drawer tank;

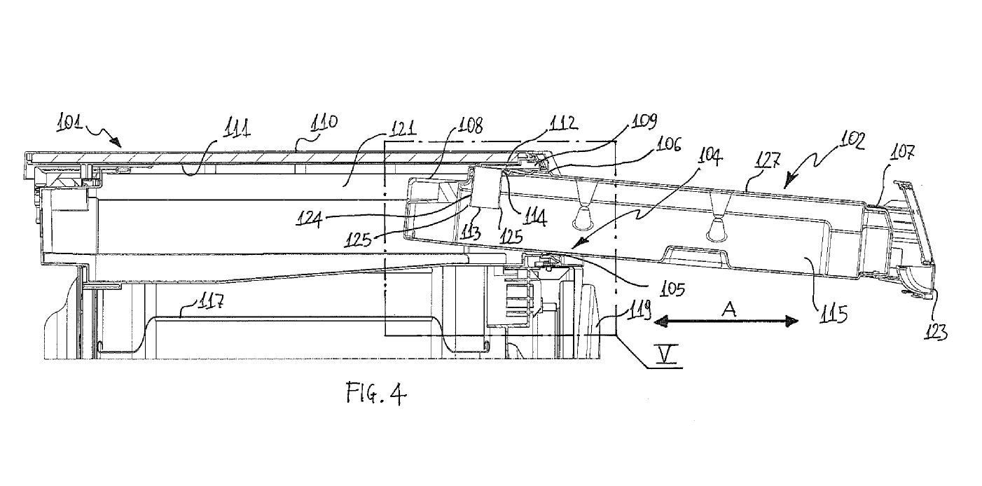

FIG. 4 shows a sectional side view of a top portion of the laundry drying machine illustrated in FIG. 3 where a condensate drawer tank has been further partially extracted from machine casing;

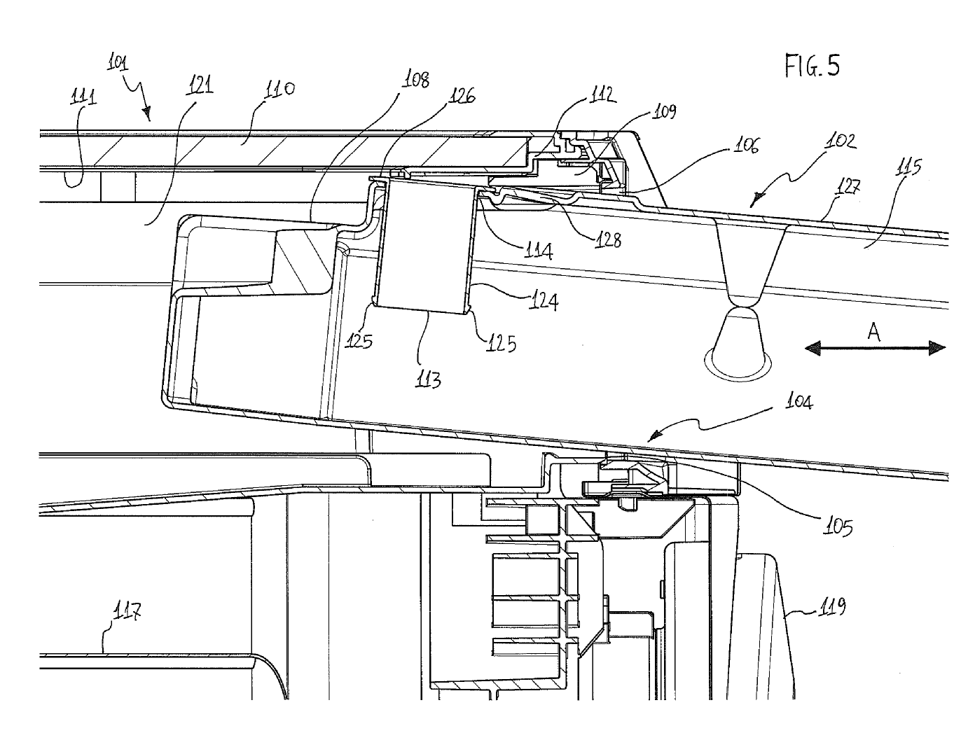

FIG. 5 shows an enlarged view of detail “V” in FIG. 4;

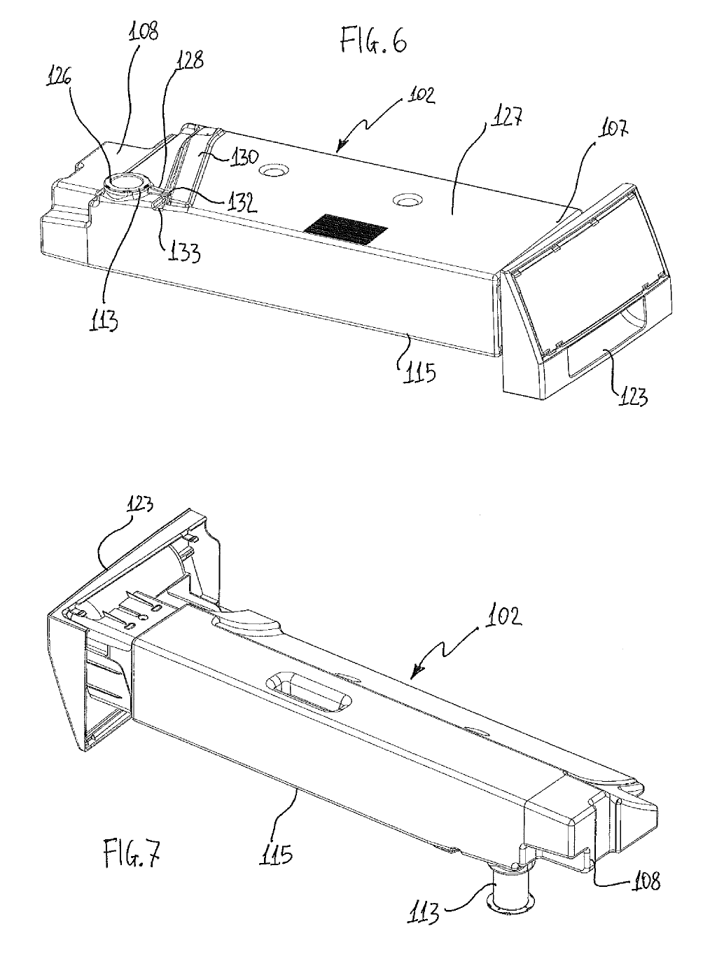

FIG. 6 shows a perspective view of an upper portion of condensate drawer tank illustrated in FIG. 3;

FIG. 7 shows a perspective view of a lower portion of the condensate drawer tank illustrated in FIG. 6;

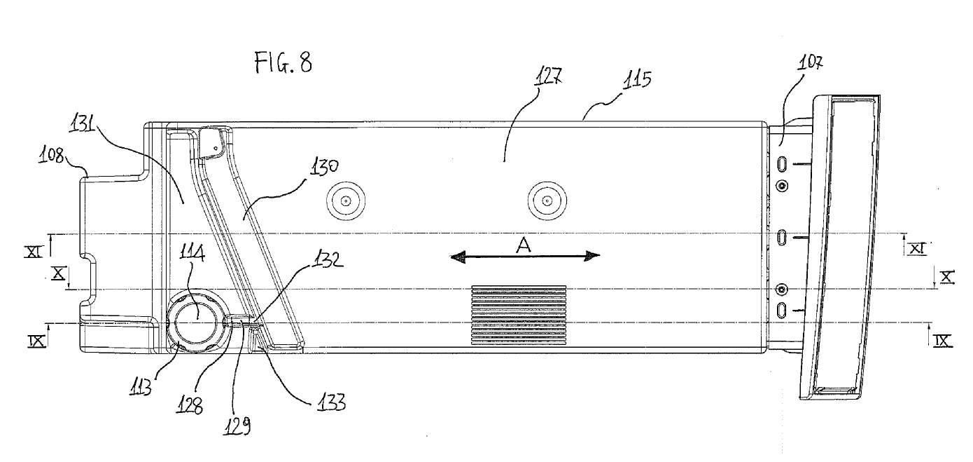

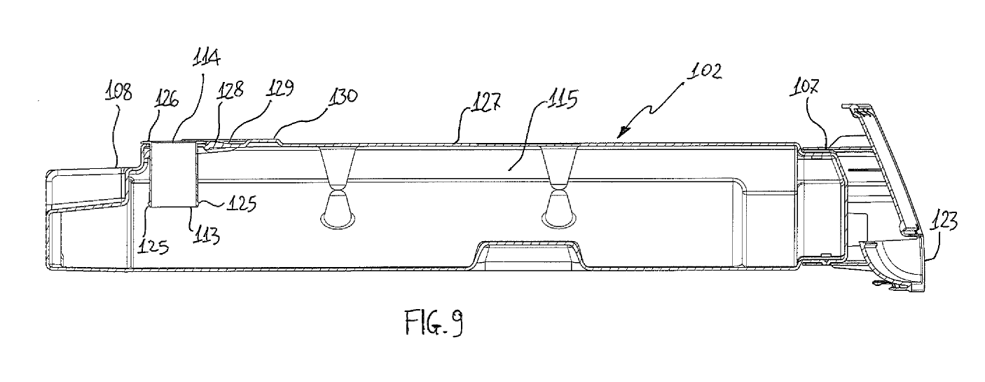

FIG. 8 shows plan view of the condensate drawer tank illustrated in FIG. 6;

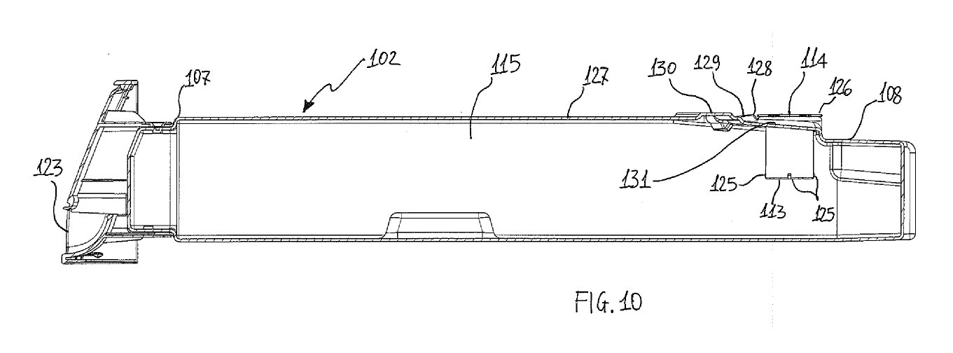

FIG. 9 shows a sectional view of the condensate drawer tank taken along line IX-IX in FIG. 8;

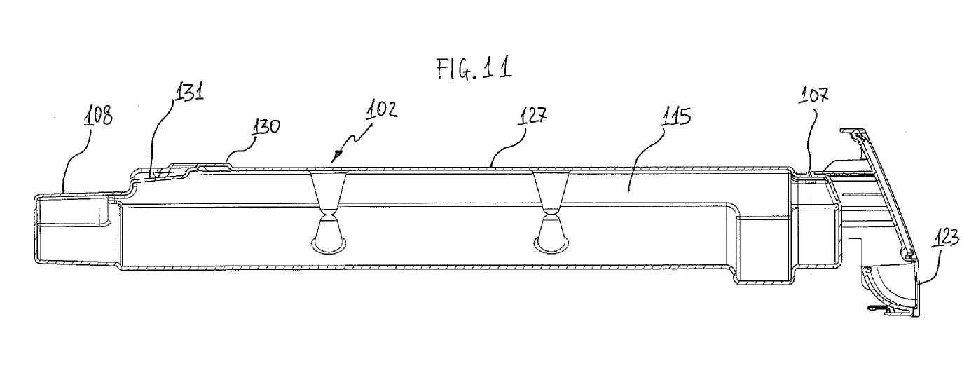

FIG. 10 shows a sectional view of the condensate drawer tank taken along line X-X in FIG. 8;

FIG. 11 shows a sectional view of the condensate drawer tank taken along line XI-XI in FIG. 8;

With reference to FIG. 3 a laundry dryer according to the invention comprises a casing 101 having a box-like structure covered by a worktop 110 that is shown in a disassemble position in FIG. 3. Said dryer is further provided with a rotating drum 117 where laundry to be dried is introduced through a loading opening 118 closable by a hinged door 119. Inside casing 101 a drying air circuit (not shown) is arranged for circulating a drying air flow through the inner chamber of drum 117. A drying air moisture condensing unit of a per sé known type (not shown) is placed within drying air circuit for removing moisture from drying air. Moisture condensed by said condensing unit is drained via a conduit 120 and poured into a pouring opening 114 formed in a condensate container 115 of a condensate drawer tank 102. The position of pouring opening 114 on container 115 is such that, when condensate drawer tank 102 is completely inserted in its housing 121, it is placed under a nozzle 122 provided at an end of conduit 120.

Condensate drawer tank 102 is slidably movable within housing 121 and may be completely extracted from the latter in order to allow condensate emptying operations. For this reason a front end 107 of the condensate drawer tank 102 is provided with a handle 123 to make such front end 107 graspable by a user hand.

In FIG. 4 it is schematically shown the condensate drawer tank 102 that has been slid along a sliding path indicated by arrows “A” in FIG. 2. Sliding path “A” is substantially parallel to worktop 110. When condensate drawer tank 102 is almost completely extracted from its housing 121, as illustrated in FIG. 4, it rotates about a resting portion 104 of the condensate container 115 through which condensate drawer tank 102 contacts a lower front edge 105 region of an opening 106 slidably receiving the condensate drawer tank 2. Due to such rotation (clockwise rotation in FIG. 4), a front end 107 of the condensate drawer tank 102 moves downwardly, and, consequently, a rear end 108 thereof moves upwardly contacting a support structure 109 of a laundry dryer frame and/or supports 112 of worktop 110 lower side 111. In particular, a bush 113 is fitted into pouring opening 114 either in a non-movable manner or so as to be slidably movable between a first position in which bush 113 is inserted within the condensate container 115 and a second position wherein said bush is extracted from the container 115 and locked on opening 114 by means of hooking elements 125 formed on the outer surface 124 of bush 113 for preventing the bush 113 to slide out of opening 114. A view of bush 113 in its second position extracted from condensate container 115 is shown in FIG. 7. In such position, bush 113 serves to control condensate flow while being poured to empty container 115. For performing this operation a user, holding the condensate drawer tank 102 by means of handle 123, needs to turn over the condensate drawer tank 102 so as to direct pouring opening 114 downwardly. Under effect of gravity, bush 113 slidably mounted into opening 114 comes out avoiding undesired condensate shedding.

In FIG. 5 it is shown an enlarged view of the contacting area between condensate drawer tank 102 and the inner parts of laundry dryer protruding from a ceiling portion of housing 121 into the latter, such as a support structure 109 of a laundry dryer frame and/or supports 112 of worktop 110 lower side 111. In order to prevent one or more of said inner parts 109, 112 from hooking an annular portion 126 of bush 113 protruding from an outer surface 127 of condensate container 115, a guiding portion 128 is formed on said surface 127 in proximity of the pouring opening 114.

Advantageously the guiding portion 128 extends on the outer surface 127 along the condensate drawer tank 102 sliding path “A”, i.e. in parallel to the latter. In this way, when the condensate drawer tank 102 is extracted from its housing 121, should an object such as a support structure 109 of a laundry dryer frame and/or supports 112 of worktop 110 lower side 111, and/or any other laundry dryer component that protrudes within housing 121 or the like, enter in contact with condensate drawer tank 102, said object is driven, i.e. guided, over the pouring opening 114 by the guiding portion 128 which contacts such object before the latter may touch bush 113 and, in particular, its annular portion 126 protruding from the outer surface 127 of condensate container 115. Consequently, such arrangement avoids the risk that bush 113 is hooked during extraction of the condensate drawer tank 102, thereby preventing drawer 102 to get blocked into housing 121, and/or being damaged.

Further advantageously, as shown in FIG. 6, guiding portion 128 is formed on the outer surface 127 of condensate container 115 in a position that is proximal to pouring opening 114 and placed between said opening 114 and a front end 107 of the condensate drawer tank 102 provided with handle 123. In this manner, when the condensate drawer tank 102 is extracted from its housing 121 along sliding path “A” (FIGS. 4 and 5) and rotates so as to contact the ceiling portion of housing 121 with its rear end 108, the guiding portion 128 encounters objects protruding within housing 121 before the bush 113, thereby protecting the latter from being hooked. In practice, the guiding portion 128 is shaped/formed so as to drive internal structural elements of the laundry dryer contacting the guiding portion 128 to slide over the pouring opening 114 when the condensate drawer tank 102 moves along the sliding path A. Advantageously the guiding portion 128 can be arranged and shaped so as to properly works non only when the drawer is extracted from the housing 121 (as in the embodiment shown in the appended figures) but also when the drawer is inserted into the housing 121. Preferably, the guiding portion 128 is integrally formed with the condensate container 115 in a single unitary piece.

With reference to FIGS. 8 to 11 it will be described the shape of guiding portion 128 and further arrangements for preventing condensate to be shed in an uncontrolled manner out of the condensate drawer tank 102.

In FIGS. 9 and 10 it can be seen that guiding portion 128 protrudes from the outer surface 127 of condensate container 115 of the same amount as the annular portion 126 of bush 113. However, for further improving the guiding portion 128 such that an object entering in contact with it can slide over the pouring opening 114 without hooking the latter, the guiding portion 128 may protrude from the outer surface 127 of condensate container 115 of an amount that is greater than the protruding amount of the annular portion 126 of bush 113. In this way at least a part of the guiding portion 128 extends higher than bush 113 relative to the outer surface 127 of condensate container 115.

FIGS. 6, 8-11 further show an embossment 130 protruding from the outer surface 127 of condensate container 115 and extending transversally to the sliding path “A” of the condensate drawer tank 102. Such embossment 130, that is advantageously arranged between the pouring opening 114 and the front end 107 provided with a graspable handle 123, serves as fluid stop in case an amount of condensate should come out of container 115 when drawer 102 is being extracted and direct towards the front end 107. In order to redirect such shed condensate towards housing 121, i.e. within the laundry dryer, a surface portion 131 of the outer surface 127 slopes down towards the rear end 108 of drawer 102. Advantageously this surface portion 131 is provided between the embossment 130 and the rear end 108. Further advantageously a part of the surface portion 131 extends around the pouring opening 114. Preferably embossment 130 is formed integrally with condensate container 115 in a single unitary piece.

In FIGS. 9 and 10 it can be seen that the guiding portion 128 is advantageously formed between the embossment 130 and the pouring opening 114. In addition the guiding portion 128 comprises a surface 129 that slopes down towards the front end 107 provided with a graspable handle 123. This arrangement allows a fluid flowing on said sloping surface 129 to be driven towards embossment 130 and here prevented from reaching the front end 107 of the condensate drawer tank 102. In particular, the guiding portion 128 joins the embossment 130 at a joining region 132 from which a draining channel 133 departs and extends along a transversal direction relative to the sliding path “A” of the condensate drawer tank 102 (see also FIG. 6). Such draining channel 133 allows fluid driven towards embossment 130 by the sloping surface 129 of the guiding portion 128 to be poured within housing 121 while drawer 103 is being extracted from laundry machine.

Conclusively it can be stated that a laundry dryer according to the invention comprises a reliable condensate water tank that prevents interference between its pouring bush and further components of the laundry drying machine when it is extracted from its housing. The same condensate water tank avoids uncontrolled condensate shedding outside the laundry drying machine and it is also adapted to prevent condensate accidentally poured around its filling opening from being shed outside the machine.

A laundry dryer as disclosed therein allows a condensate water tank to be extracted from its housing without any blocking even in case dimensional tolerances and/or assembling tolerance are excessive.

Advantageously, a laundry dryer comprising a condensate water tank according to the invention may reliably avoid that a pouring bush associated to a condensate container is hooked when drawer is extracted from its housing even when said pouring bush itself is slidably mounted in a condensate container opening for facilitating emptying operations.

A condensate water tank applicable to the present inventive laundry dryer may be produced without cost increasing compared to prior art condensate water tanks.

1. A laundry dryer comprising a drying air circuit for circulating a drying air flow through laundry to be dried, a drying air moisture condensing unit and a condensate drawer tank which is movable along a sliding path relative to a housing and comprises a condensate container having a pouring opening for collecting moisture condensed from said drying air flow, wherein said condensate drawer tank comprises a guiding portion formed on an outer surface of the condensate container and extending parallel to said sliding path, said guiding portion being arranged in proximity of a pouring opening for driving at least a structural element of the laundry dryer to slide over the pouring opening when the condensate drawer tank moves along the sliding path.

2. A laundry dryer according to claim 1 wherein a bush is fitted into said pouring opening and comprises an annular portion protruding from said opening.

3. A laundry dryer according to claim 2 wherein said bush is slidably associated to said pouring opening so as to be movable from a first resting position in which said bush is inserted within the condensate container and a second position wherein said bush is extracted from the container and locked on the pouring opening.

4. A laundry dryer according to claim 2 wherein the guiding portion and the bush protrude of the same amount from the outer surface of the condensate container.

5. A laundry dryer according to claim 2 wherein the guiding portion protrudes from the outer surface of the condensate container more than said bush so as to comprise a part extending higher than the bush relative to the outer surface.

6. A laundry dryer according to claim 1 wherein said guiding portion slopes down towards a graspable front end of the condensate drawer tank.

7. A laundry dryer according to claim 1 wherein said guiding portion is formed integrally with the condensate container as a single unitary piece.

8. A laundry dryer according to claim 1 wherein an embossment is arranged transversally to the condensate drawer tank sliding path on said outer surface between the pouring opening and a graspable front end of condensate drawer tank.

9. A laundry dryer according to claim 8 wherein a portion of the outer surface slopes down towards a rear end of the condensate drawer tank and is provided between the embossment and said rear end.

10. A laundry dryer according to claim 9 wherein a part of the portion of the outer surface extends around the pouring opening.

11. A laundry dryer according to claim 8 wherein said guiding portion is formed between the embossment and the pouring opening.

12. A laundry dryer according to claim 8 wherein said embossment is formed integrally with condensate container in a single unitary piece.

13. A laundry dryer according to claim 1 wherein said guiding portion joins to an embossment arranged transversally to the condensate drawer tank sliding path at a joining region and a draining channel departs from said joining region along a further transversal direction relative to said sliding path.

14. A laundry dryer according to claim 9 wherein said guiding portion is formed between the embossment and the pouring opening.

15. A laundry dryer according to claim 10 wherein said guiding portion is formed between the embossment and the pouring opening.

16. A laundry dryer according to claim 2 wherein said guiding portion joins to an embossment arranged transversally to the condensate drawer tank sliding path at a joining region and a draining channel departs from said joining region along a further transversal direction relative to said sliding path.

17. A laundry dryer according to claim 6 wherein said guiding portion joins to an embossment arranged transversally to the condensate drawer tank sliding path at a joining region and a draining channel departs from said joining region along a further transversal direction relative to said sliding path.

18. A laundry dryer according to claim 7 wherein said guiding portion joins to an embossment arranged transversally to the condensate drawer tank sliding path at a joining region and a draining channel departs from said joining region along a further transversal direction relative to said sliding path.
